(19) United States
(12) Patent Application Publication
(10) Pub. No.: US 2007/0236416 A1
(43) Pub. Date: Oct. 11, 2007

(54) METHOD OF DRIVING PLASMA DISPLAY PANEL

(75) Inventor: Byung Joon RHEE, Yongin-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/685,888

(22) Filed: Mar. 14, 2007

(30) Foreign Application Priority Data
Mar. 14, 2006 (KR) 10-2006-0023372

(51) Int. Cl. G09G 3/28

(52) U.S. Cl. 345/60

(57) ABSTRACT

Disclosed herein is a method of driving a Plasma Display Panel (PDP). The PDP driving method includes the steps of providing a first group of sustain pulses to scan electrodes in a sustain discharge period, and providing a second group of sustain pulses to sustain electrodes in the sustain discharge period so that the second group of pulses alternates with the first group of pulses. The sustain voltage of a first sustain pulse of the first group of sustain pulses is set to a voltage higher than a sustain voltage of remaining sustain pulses of the first group of sustain pulses using a voltage source for driving the scan electrodes in a reset period.

### BACKGROUND OF THE INVENTION

1. Field of the Invention

The present invention relates generally to a method of driving a Plasma Display Panel (PDP), and, more particularly, to a method of driving a PDP that can secure a voltage margin necessary for sustain discharge and can stably generate sustain discharge even in a high-temperature environment.

2. Description of the Related Art

PDPs are display devices that use a phenomenon in which visible rays are generated when ultraviolet rays, which are generated through gas discharge, excite a phosphor. PDPs have advantages in that they are thinner and lighter than Cathode Ray Tubes (CRTs) and can implement high-definition, large-sized screens. In general, a PDP includes a plurality of discharge cells arranged in a matrix, and each of the discharge cells corresponds to a single sub-pixel of a screen.

FIG. 1 is an exploded perspective view showing the structure of a conventional three-electrode Alternating Current (AC) surface discharge-type PDP. Referring to FIG. 1, each discharge cell includes a scan electrode Y and a sustain electrode Z formed in an upper substrate 1, and an address electrode X formed in a lower substrate 9. The scan electrode Y and the sustain electrode Z are generally made of Indium-Tin-Oxide (ITO). Bus electrodes 3, made of at least one of Ag, Cu, and Cr, are respectively formed on the scan and sustain electrodes Y and Z, so as to reduce voltage drop attributable to the high resistance characteristics of the scan and sustain electrodes Y and Z.

An upper dielectric layer 4 and a protective film 5 are sequentially placed on the upper substrate 1, in which the scan electrode Y and the sustain electrode Z are formed in parallel with each other. The protective film 5 is generally made of magnesium oxide MgO so as to prevent damage to the upper dielectric layer 4 due to sputtering generated during plasma discharge, but also to increase the efficiency of emission of secondary electrons.

A lower dielectric layer 8 and barrier ribs 6 are formed on the lower substrate 9, on which address electrodes X are formed. A phosphor 7 is applied to the surfaces of the lower dielectric layer 8 and the barrier ribs 6. The address electrodes X are arranged in a direction perpendicular to the scan electrode Y and the sustain electrode Z, and the barrier ribs 6 are arranged in a direction parallel to the address electrodes X, and prevent ultraviolet rays and visible light from leaking to neighboring cells. The phosphor 7 is excited by ultraviolet rays generated during plasma discharge, and generates a visible ray corresponding to any one of Red R, Green G and Blue B. Ne+Xe and Penning gas for gas discharge are encapsulated in discharge spaces that are defined by upper substrates 1, lower substrates 9, and the barrier ribs 6.

In a PDP having the above-described structure, a discharge cell is selected by a facing surfaces discharge between an address electrode X and a scan electrode Y, and then the discharge in the selected cell is sustained by a surface discharge between the scan electrode Y and a sustain electrode Z. In the discharge cell, the phosphor 7 is made to emit light using ultraviolet rays generated during the sustain discharge, thereby emitting visible rays from the cell. As a result, discharge cells can realize gray-scale levels through the control of the periods during which discharges are sustained, so that the PDP in which the discharge cells are arranged in a matrix form can display images.

FIG. 2 is a diagram showing the gray-scale level implementation method of an Address-and-Display-period Separated (ADS) driving method, which is a representative conventional PDP driving method. Referring to FIG. 2, in the ADS driving method, in order to represent gray-scale levels (for example, 256 gray-scale levels), a plurality of (for example, 8) sub-fields SF having different brightnesses, that is, different light emitting periods, is generally set in one TV field (generally, 16.67 ms) representing an image. In this case, respective sub-fields have sustain discharge periods corresponding to weights of 2⁰, 2¹, 2², 2³, 2⁴, 2⁵, 2⁶, and 2⁷, and 256 (=2⁸) gray-scale levels can be represented using combinations of the sub-fields. Each sub-field is composed of a reset period for generating uniform discharge, an address period for selecting discharge cells, and a sustain discharge period for implementing gray-scale levels depending on the numbers of discharges.

FIG. 3A is a diagram showing an example of a driving waveform according to the PDP driving method shown in FIG. 2.

Referring to FIG. 3A, in the setup period SU of a reset period, a voltage of a rising ramp waveform Ramp-up rising from a predetermined positive voltage to a setup voltage Vsetup at a predetermined slope is simultaneously supplied to all of the scan electrodes Y. At the same time, a ground voltage GND is supplied to the sustain electrodes Z and the address electrodes X. Setup discharge, which is weak discharge, is generated between the scan electrodes Y, the sustain electrodes Z, and the address electrode X throughout the discharge cells of a full screen, due to the voltage of the rising ramp waveform Ramp-up, so that positive wall charges are accumulated on the address electrodes X and the sustain electrodes Z, and negative charges are accumulated on the scan electrodes Y.

In the setdown period SD of a reset period, a voltage of a falling ramp waveform Ramp-down falling from a setup voltage Vsetup to a predetermined positive voltage and then falling to a negative setdown voltage −Vsetdown at a predetermined slope is supplied to the scan electrodes Y. While the voltage of a falling ramp waveform Ramp-down is supplied, a ground voltage GND is continuously supplied to the sustain electrodes Z and the address electrodes X. Setdown discharge, which is weak discharge, is generated between the scan electrodes Y, the sustain electrodes Z, and the address electrodes X due to the voltage of a falling ramp waveform Ramp-down, so that redundant wall charges unnecessary for address discharge are eliminated among wall charges created during setup discharge. With regard to the variation in wall charge in the setdown period SD, there is little variation in wall charge on the address electrodes X, the number of negative wall charges generated on the scan electrodes Y during the setup discharge is somewhat reduced due to the setdown discharge, and a number of negative charges equal to the number of reduced charges is accumulated on the sustain electrodes Z.

In an address period, a negative scan reference voltage −Vsc is supplied, and then a scan pulse voltage −Vy is sequentially supplied to the scan electrodes Y and, simultaneously, a positive data pulse voltage Va is supplied to the address electrodes X in synchronization with the application of the scan pulse voltage −Vy. As the difference between the scan pulse voltage −Vy and the data pulse voltage Va is added to a wall voltage generated in the reset period, address discharge is generated in cells to which the data pulse voltage Va is applied. An amount of wall charge equal to the amount of charge that can generate sustain discharge when a sustain pulse is supplied in a sustain discharge period is generated in each of the cells selected by the address discharge. In the address period, a predetermined bias voltage Vds is supplied to the sustain electrodes Z.

In a sustain discharge period, a sustain pulse is supplied alternately to the scan electrodes Y and the sustain electrodes Z. Whenever a sustain pulse is applied, sustain discharge, that is, display discharge, is generated between the scan electrodes Y and the sustain electrodes Z in cells, selected by the address discharge, as the wall voltage of each cell is added to the sustain pulse voltage Vs. In this case, a pulse wider than other sustain pulses may be employed as the first sustain pulse of a sustain pulse applied to the scan electrodes, so that sustain discharge can be stably initiated.

Meanwhile, in the case where sustain pulses are supplied to a panel in the sustain discharge period, a voltage having a sustain pulse waveform composed of −Vs/2 and Vs/2 may be applied to the scan electrodes Y and the sustain electrodes Z, as shown in FIG. 3B, as long as the voltage difference between the scan electrodes Y and the sustain electrodes Z is a voltage Vs that is required for sustain discharge.

FIG. 4 is a diagram showing the overall construction of a device for driving the PDP shown in FIG. 1.

Referring to FIG. 4, the prior art device for driving a three-electrode AC surface discharge-type PDP includes a PDP 21 configured such that m×n discharge cells 20 are arranged in a matrix to be connected to scan electrode lines Y1 to Ym, sustain electrode lines Z1 to Zm and address electrode lines X1 to Xn, a scan driving unit 22 for supplying the above-described scan driving waveforms to the scan electrode lines Y1 to Ym, a sustain driving unit 23 for simultaneously supplying the above-described sustain driving waveforms to the sustain electrode lines Z1 to Zm, an address driving unit 24 for supplying the above-described address driving waveforms to the address electrode lines X1 to Xn, and a control circuit unit 25 for supplying control signals to the driving units based on external display data D, horizontal synchronization signals H, vertical synchronization signals V, and clock signals. Control is performed such that, in the reset period and the sustain period, each of the above-described setup and setdown pulses and sustain pulses is applied simultaneously to all of the scan electrode lines Y1 to Ym, while, in the address period, an address pulse is supplied sequentially to the lines from the first line thereof to the last line.

However, recently, with the increase in the size of a display screen, in the case where a PDP is driven using the above-described prior art driving method, an address pulse is supplied sequentially to lines, so that the difference between the time at which the address pulse of the scan driving waveforms, that is, the scan pulse voltage −Vy, is applied to the first line and the time at which the voltage is applied to the last line increases, with the result that initial conditions for the first line are different from those for the last line. That is, as shown in FIG. 5, if the width of a scan pulse is about 1.5 μs when a 42-inch XGA (1024×768)-class PDP is driven, the difference between the time at which addressing discharge is generated between a first scan electrode line Y1 and a first address electrode line X1 and the time at which addressing discharge is generated between a last scan electrode line Y768 and a last address electrode line X768 is about 1.152 ms (768×1.5 μs). However, when a PDP in a class higher than the above-described XGA class is driven, a reset operation is performed simultaneously on all of the lines. Accordingly, in the case of the addressing of the last line, wall charges accumulated after reset are combined with each other before the occurrence of addressing discharge, so that a wall charge state for the last line is different from the wall charge for the first line, with the result that the addressing conditions for the last line are different from the addressing conditions for the first line. As a result, according to the above-described prior art, weak discharge is caused at the time of addressing discharge due to insufficient wall charges in the last line, therefore the minimum value Vs,min required for sustain discharge is increased, thereby causing a problem in that sustain discharge becomes unstable.

Furthermore, in the case where a PDP is driven in an environment having a high temperature equal to or higher than 60° C., the above-described recombination phenomenon is prominent due to the above-described driving waveform, so that a problem arises in that unlighted discharge cells 60 may appear not only in the last line but also in lines adjacent to the last line due to erroneous discharge, as shown in FIG. 6.

The reasons why erroneous discharge due to recombination is generated in an environment having a high temperature are discussed in detail below with reference to FIG. 7A to FIG. 7C. In an environment having a high temperature equal to or higher than 60° C., the wall charge state of a discharge cell, set up immediately after reset in a first line, is the same as a wall charge state at the time of addressing after reset, as shown in FIG. 7A, a wall charge state set up after reset in a last line is the same as the two former states, as shown in the upper portion of FIG. 7B, and a wall charge state at the time of addressing the last line after reset exhibits a decrease in the number of negative charges accumulated on the sustain electrodes, as shown in the lower portion of FIG. 7B. It is inferred that the variation in the wall charge state is caused due to a phenomenon in which negative charges on the scan electrodes are recombined with other wall charges due to thermal energy (see reference numeral 70) while a PDP is scanned during a time period spanning from reset to the time of addressing a last line as shown in FIG. 7C, unlike the case in a first line. Due to this reason, the loss of wall charges is incurred on the last line, so that an addressing voltage is decreased. Accordingly, in a sustain discharge period, a minimum voltage V_{s,min} required for sustain discharge, for which a sustain pulse is applied, is increased above that for the first line, so that a problem arises in that sustain discharge becomes unstable.

### SUMMARY OF THE INVENTION

Accordingly, the present invention has been made keeping in mind the above problems occurring in the prior art, and an object of the present invention is to provide a method of driving a PDP, in which an initial sustain pulse voltage in the early state of sustain discharge is increased using a setup voltage, so that a prior art driving circuit can be used without change, a voltage margin required for the sustain discharge can be secured, and sustain discharge can be stably generated even in a high-temperature environment.

In order to accomplish the above object, the present invention provides a method of driving a PDP, including the steps of providing a first group of sustain pulses to scan electrodes in a sustain discharge period; and providing a second group of sustain pulses to sustain electrodes in the sustain discharge period so that the second group of pulses alternates with the first group of pulses; wherein a sustain voltage of a first sustain pulse of the first group of sustain pulses is set to a voltage higher than a sustain voltage of remaining sustain pulses of the first group of sustain pulses using a voltage source for driving the scan electrodes in a reset period.

Preferably, the sustain voltage of the first sustain pulse is substantially equal to the largest of voltages that are applied to the scan electrodes.

Furthermore, the sustain voltage of the first sustain pulse is substantially equal to the largest of voltages that are applied to the scan electrodes in the reset period.

Preferably, the pulse width of the first sustain pulse is equal to the pulse width of the remaining sustain pulses.

Preferably, the pulse width of a first sustain pulse of the second group of sustain pulses is larger than the pulse widths of remaining stain pulses of the second group of sustain pulses.

The remaining pulses of the first group of sustain pulses and the second group of sustain pulses are pulses each of which includes a ground voltage and a voltage required for sustain discharge, or pulses each of which includes voltages that have a magnitude of half of a voltage required for sustain discharge and opposite polarities.

Preferably, a ground voltage is applied to the sustain electrodes while the first sustain pulse of the first group of sustain pulses is applied.

Preferably, the PDP driving method further includes the step of applying a negative scan reference voltage and a scan pulse voltage to the scan electrodes in an address period.

Preferably, the PDP driving method further includes the step of applying a predetermined bias voltage to the sustain electrodes in an address period, wherein the bias voltage is greater than zero and smaller than the voltage required for sustain discharge.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing the structure of a conventional three-electrode AC surface discharge-type PDP;

FIG. 2 is a diagram showing the gray-scale level implementation method of an Address-and-Display-period Separated (ADS) driving method, which is a representative conventional PDP driving method;

FIGS. 3A and 3B are diagrams showing examples of a driving waveform according to the PDP driving method shown in FIG. 2;

FIG. 4 is a diagram showing the overall construction of a device for driving the PDP shown in FIG. 1;

FIG. 5 is a diagram illustrating the difference between the time at which an address pulse is applied to a first line and the time at which an address pulse is applied to a last line, when a 42-inch XGA (1024×768)-class PDP is driven;

FIG. 6 is a diagram illustrating the problem with the prior art, in which unlighted cells appear due to erroneous discharge in an area adjacent to a last line in an environment involving a high temperature equal to or higher than 60° C.;

FIGS. 7A to 7C are diagrams illustrating the reason why erroneous discharge is generated, as shown in FIG. 6;

FIG. 8 is a diagram showing a driving waveform that is applied to scan electrodes according to a preferred embodiment of the present invention;

FIG. 9 is a diagram showing another example of a driving waveform applied to scan electrodes according to a preferred embodiment of the present invention;

FIG. 10 is a diagram showing another example of a driving waveform applied to scan electrodes according to a preferred embodiment of the present invention; and

FIG. 11 is a diagram schematically showing a device for driving a PDP according to a preferred embodiment of the present invention.

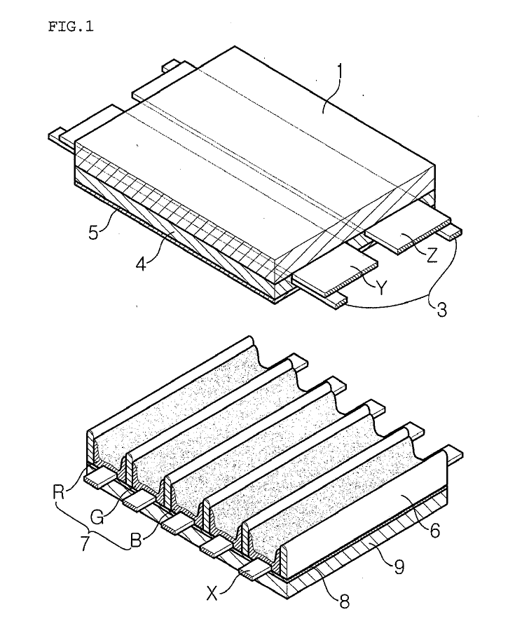

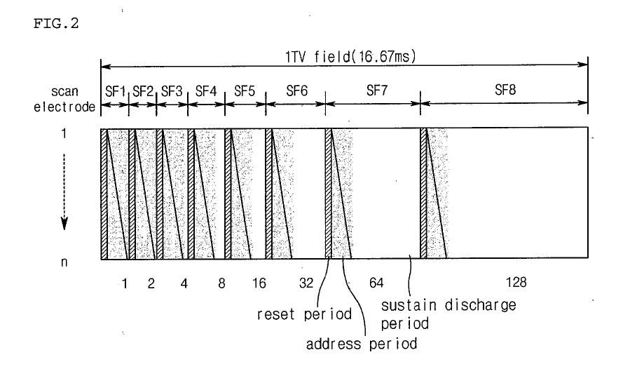

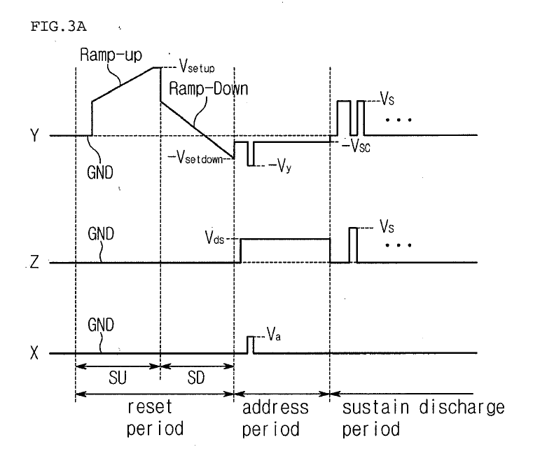

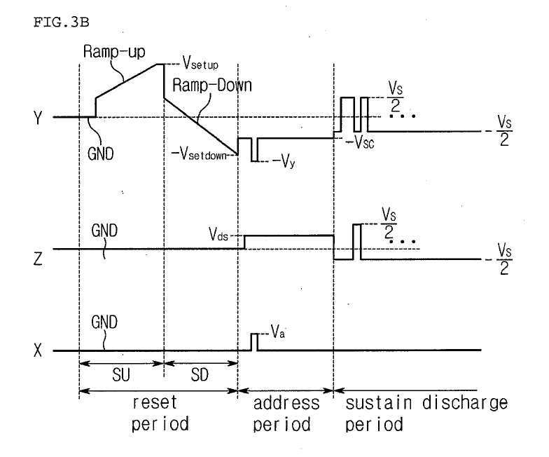

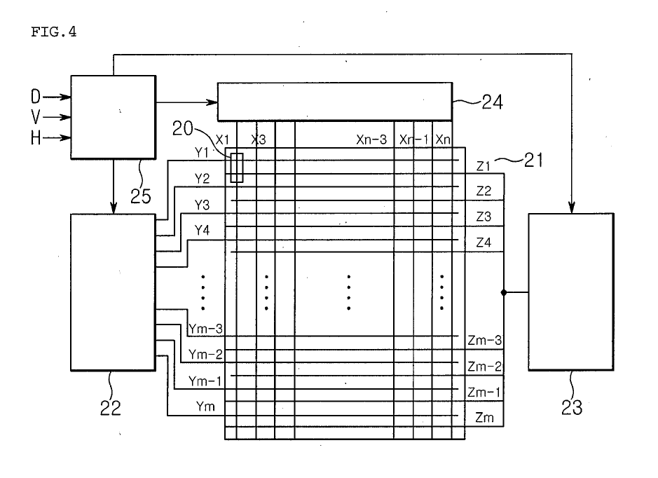

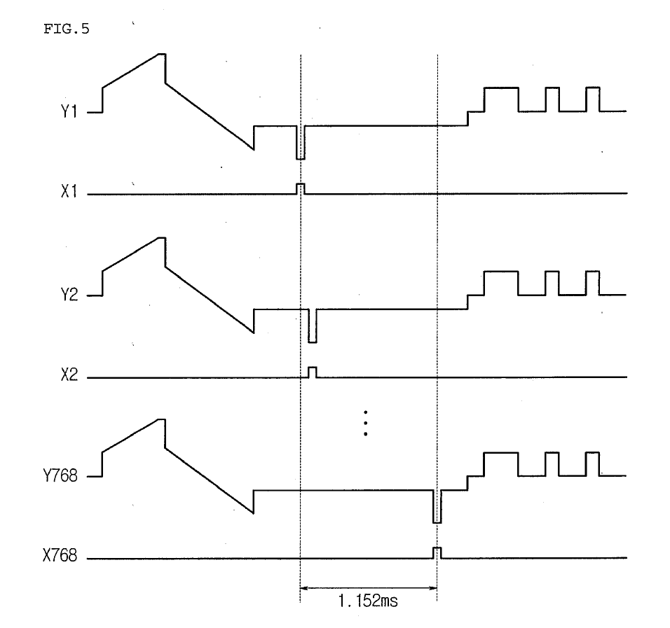

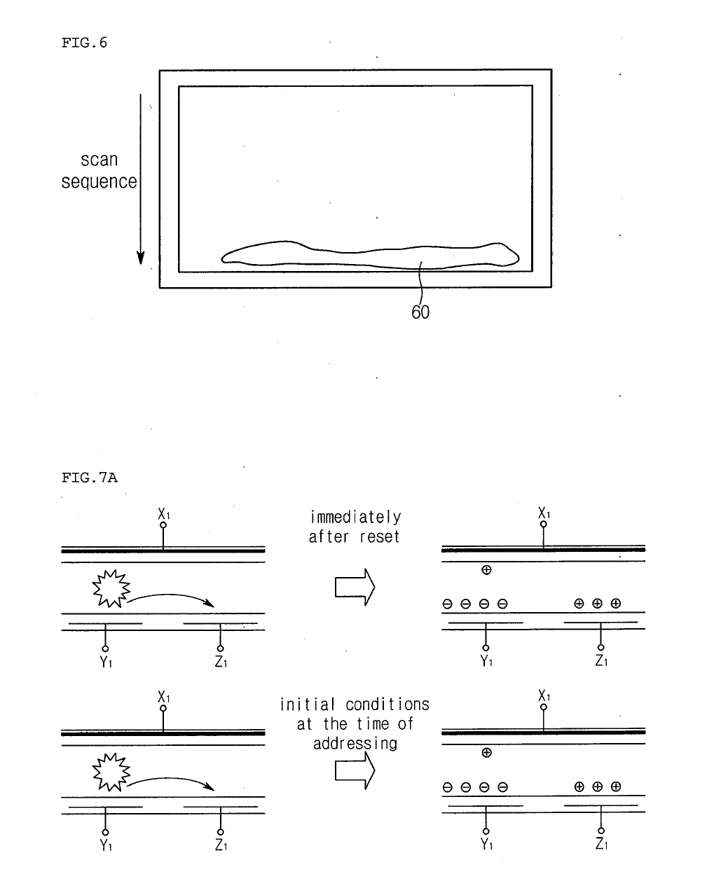

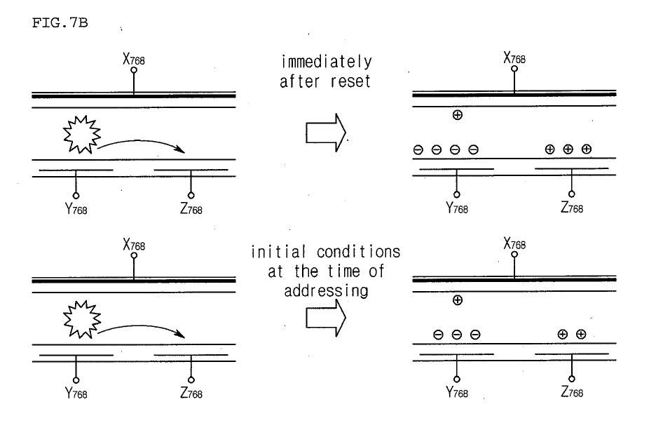

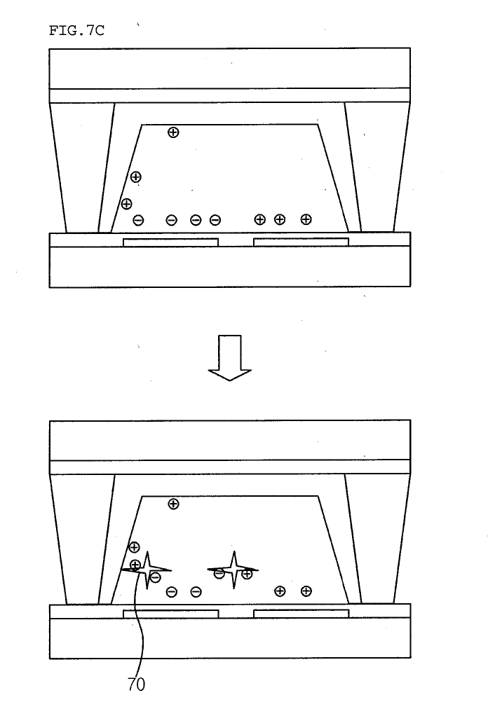

### DESCRIPTION OF THE PREFERRED EMBODIMENTS

Reference now should be made to the drawings, in which the same reference numerals are used throughout the different drawings to designate the same or similar components.

Preferred embodiments of the present invention are described in detail with reference to the accompanying drawings below.

FIG. 8 is a diagram showing a driving waveform that is applied to scan electrodes according to a preferred embodiment of the present invention.

Referring to FIG. 8, in a first preferred embodiment of the present invention, a voltage having the same value as the setup voltage Vsetup of a reset period is applied to scan electrodes as the first sustain voltage of a group of scan pulses applied to the scan electrodes. Meanwhile, as in the prior art technology, a voltage having the value of a sustain voltage Vs required for sustain discharge is applied as the sustain voltage of other sustain pulses following the first sustain pulse and the sustain voltage of sustain pulses applied to sustain electrode lines. Accordingly, according to a driving waveform applied to the scan electrode lines based on the prior art technology, even if a wall voltage created by addressing discharge is reduced on a last line or a line adjacent to the last line, sustain discharge can be stably generated without needing to increase the minimum value Vs,min of a voltage required for a sustain discharge by applying a setup voltage Vsetup, having a high value, as a first sustain pulse voltage, so that erroneous discharge does not occur even if the surrounding temperature is high. Furthermore, the ability of a PDP to represent low gray-scale levels can be improved by applying a setup voltage Vsetup as a first sustain pulse voltage, thereby helping improve image quality. Moreover, according to the present embodiment, sustain discharge can be stably initiated, even if the width of the first sustain pulse of a group of sustain pulses applied to the scan electrodes is not increased so as to allow the sustain discharge to be stably initiated, not as in the prior art technology.

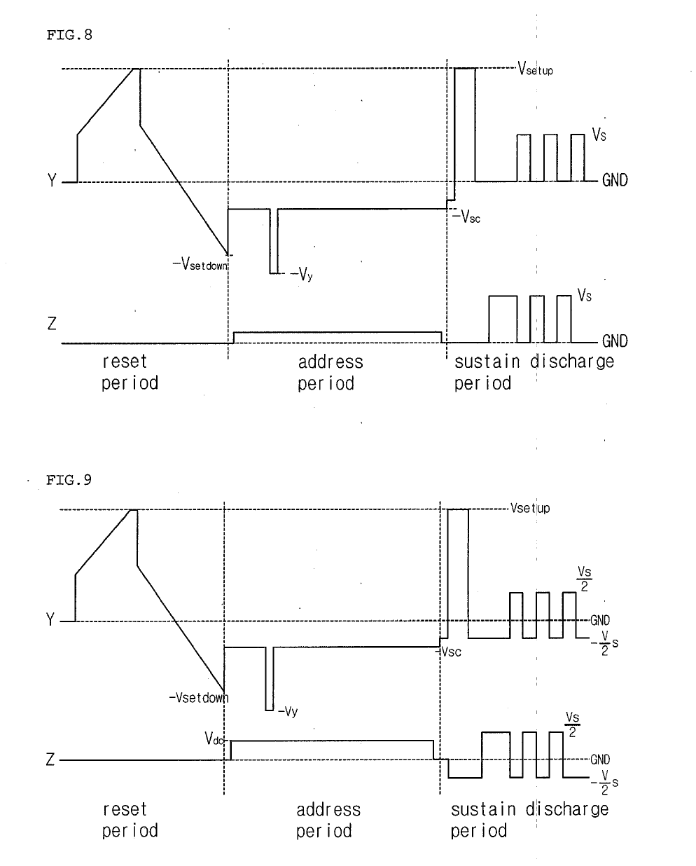

FIG. 9 is a diagram showing a sustain pulse waveform applied to scan electrodes according to a second preferred embodiment of the present invention. The present embodiment is the same as the first embodiment, with the sole exception that each of the remaining sustain pulses other than the first sustain pulse and sustain pulses applied to sustain electrodes is composed of two voltages that are the same in absolute value as a voltage Vs/2, which corresponds to half of the voltage required for sustain discharge, but are different in sign from the voltage Vs/2. In the present embodiment, a voltage identical to the setup voltage Vsetup of a preset waveform is applied as the sustain voltage of a first sustain pulse, so that sustain discharge can be stably generated without needing to increase the minimum value Vs,min of a voltage required for the sustain discharge by applying a setup voltage Vsetup as a first sustain pulse voltage, as in the first embodiment, so that erroneous discharge is not generated, even if the surrounding temperature is high. As a result, the ability of a PDP to present low gray-scale levels can be improved, thereby helping improve image quality.

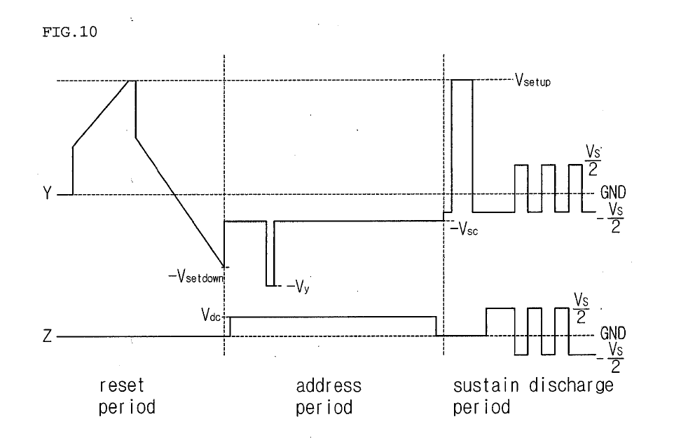

The driving waveform of FIG. 10 is the same as that of FIG. 9. This drawing shows the case where a voltage identical to a setup voltage is applied to scan electrodes as a first sustain pulse and a ground voltage is applied to sustain electrodes while the first sustain pulse is applied to the scan electrodes. Accordingly, according to the driving waveform, in addition to the above-described advantages associated with the second embodiment, the present embodiment has the advantage of improved driving efficiency because it is not necessary to apply a negative voltage −Vs/2 to sustain electrodes as the voltage of the first sustain pulse of a group of sustain pulses that is applied to the sustain electrodes.

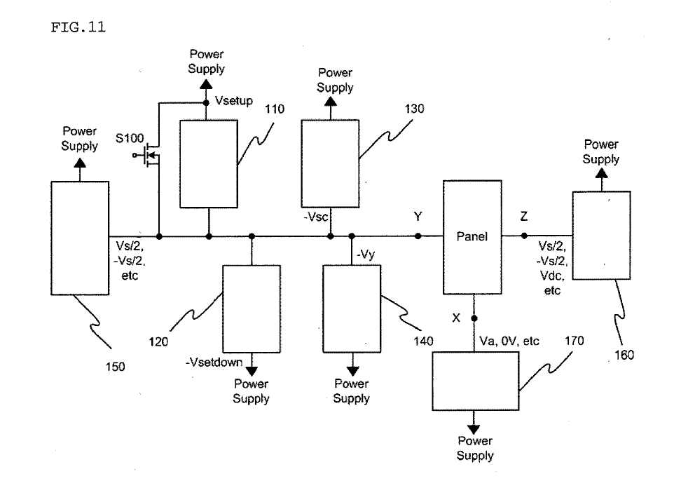

FIG. 11 is a diagram schematically showing a device for driving a PDP according to a preferred embodiment of the present invention.

FIG. 11 illustrates the case where the PDP driving device supplies a voltage of a sustain pulse waveform composed of −Vs/2 and Vs/2 to scan electrodes Y and sustain electrodes Z. Although a detailed illustration is omitted here, each voltage supply unit is formed of a circuit, including a switch that is selectively opened or closed at appropriate times in response to the control signal of a control circuit unit (not shown) so as to supply a driving waveform, such as that shown in FIG. 9 or 10, to a panel.

In a reset period, a setup voltage supply unit 110 is supplied with a setup voltage Vsetup from a power supply unit (not shown) and supplies a voltage of a rising ramp waveform rising from a predetermined voltage to the setup voltage Vsetup to the scan electrode Y, and a setdown voltage supply unit 120 is supplied with a setdown voltage Vsetdown from the power supply unit and supplies a voltage of a falling ramp waveform, falling to the setdown voltage Vsetdown, to the scan electrodes Y. While the voltages having a rising ramp waveform and a falling ramp waveform are supplied to the scan electrodes Y, a ground voltage is supplied to the sustain electrodes Z through a sustain driving unit 160.

In an address period, a scan reference voltage supply unit 130 and a scan pulse voltage supply unit 140 are supplied with a specific voltage from the power supply unit and supply a voltage waveform, composed of a scan reference voltage −Vsc and a scan pulse voltage −Vy, as shown in FIG. 9 or 10, sequentially to the scan electrodes Y, and an address driving unit 170 supplies a data pulse voltage Va to address electrodes X in synchronization with the scan pulse voltage −Vy. In this period, a predetermined bias voltage Vdc is supplied to the sustain electrodes Z from the sustain driving unit 160.

In a sustain discharge period, at the same time that a ground voltage is supplied to the address electrodes X, the Y sustain driving unit 150 and the Z sustain driving unit 160 are supplied with appropriate voltages from the power supply unit and supply a sustain pulse waveform composed of −Vs/2 and Vs/2 to the scan electrodes Y and the sustain electrodes Z.

The PDP driving device according to the present invention may further include a switch S100 between the setup voltage supply unit 110 and a sustain pulse supply path. Accordingly, by turning on the switch S100 at the time at which a first sustain pulse is supplied to the scan electrodes Y in a sustain discharge period, a voltage having the same value as a setup voltage Vsetup can be supplied from the power supply unit through the sustain pulse supply path to the scan electrodes Y.

A method of applying a setup voltage Vsetup as the sustain voltage Vs of a first sustain pulse as described above can be simply implemented without changing the construction of the prior art PDP driving circuit or adding a separate construction. Although the respective voltage supply units are schematically illustrated in the driving circuit shown in FIG. 11 for ease of description, the present invention can apply a voltage having the same value as a setup voltage Vsetup to the scan electrode line as the sustain voltage of a first sustain pulse by adding, for example, a single switch to a driving circuit, so that a prior art voltage source for supplying the setup voltage can be used.

The above-described preferred embodiments of the present invention are only illustrative of the present invention, therefore various modifications, variations and substitutions can be made based on the preferred embodiments. For example, although, in FIG. 11, respective voltage supply units are schematically illustrated for ease of description, any type of voltage supply units can realize the objects of the present invention as long as a voltage having the same value as a setup voltage Vsetup is applied to scan electrode lines as the sustain voltage of a first sustain pulse applied to the scan electrode lines, regardless of the construction of the voltage supply units and the type of voltage waveform applied to the electrode lines. Accordingly, the present invention should not be construed as limited to the particular examples set forth in the detailed description, but should be understood to include the technical spirit of the present invention defined by the attached claims and all modifications, equivalents and substitutes that fall within the scope thereof.

According to the present invention, an initial sustain pulse voltage in the early state of sustain discharge is increased using a setup voltage, so that a prior art driving circuit can be used without change, a voltage margin required for sustain discharge can be secured even in an environment having a high temperature equal to or higher than 60° C., and the ability to represent low gray-scale levels can be improved, thereby being capable of improving image quality.

What is claimed is:

1. A method of driving a Plasma Display Panel (PDP), comprising the steps of:
providing a first group of sustain pulses to scan electrodes in a sustain discharge period; and
providing a second group of sustain pulses to sustain electrodes in the sustain discharge period so that the second group of pulses alternates with the first group of pulses;
wherein a sustain voltage of a first sustain pulse of the first group of sustain pulses is set to a voltage higher than a sustain voltage of remaining sustain pulses of the first group of sustain pulses using a voltage source for driving the scan electrodes in a reset period.

2. The method as set forth in claim 1, wherein the sustain voltage of the first sustain pulse is substantially equal to a largest voltage of voltages that are applied to the scan electrodes.

3. The method as set forth in claim 1, wherein the sustain voltage of the first sustain pulse is substantially equal to a largest voltage of voltages that are applied to the scan electrodes in the reset period.

4. The method as set forth in claims 2 or 3, wherein a pulse width of the first sustain pulse is equal to a pulse width of the remaining sustain pulses.

5. The method as set forth in claim 4, wherein a pulse width of a first sustain pulse of the second group of sustain pulses is larger than pulse widths of remaining stain pulses of the second group of sustain pulses.

6. The method as set forth in claims 2 or 3, wherein the remaining pulses of the first group of sustain pulses and the second group of sustain pulses are pulses each of which includes a ground voltage and a voltage required for sustain discharge.

7. The method as set forth in claims or 3, wherein the remaining pulses of the first group of sustain pulses and the second group of sustain pulses are pulses each of which includes voltages that have a magnitude of half of a voltage required for sustain discharge and opposite polarities.

8. The method as set forth in claim 7, wherein a ground voltage is applied to the sustain electrodes while the first sustain pulse of the first group of sustain pulses is applied.

9. The method as set forth in claims 2 or 3, further comprising the step of applying a negative scan reference voltage and a scan pulse voltage to the scan electrodes in an address period.

10. The method as set forth in claims 2 or 3, further comprising the step of applying a predetermined bias voltage to the sustain electrodes in an address period.

11. The method as set forth in claim 10, wherein the bias voltage is greater than zero and smaller than the voltage required for sustain discharge.
